(19) United States
(12) Patent Application Publication
(10) Pub. No.: US 2006/0254625 A1
(43) Pub. Date: Nov. 16, 2006

(54) Sprayer and cleaning apparatus using the same

(75) Inventors: Yi-Yen Chen, Miao-Li (TW); Yu-Ying Chan, Miao-Li (TW); Wen Cheng Hsu, Miao-Li (TW); Ching Lung Wang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/130,509

(22) Filed: May 16, 2005

(51) Int. Cl. B08B 3/00

(52) U.S. Cl. 134/61; 134/198

(57) ABSTRACT

A cleaning apparatus for cleaning a substrate (4) includes a brush-cleaning tank, a rinsing tank, and a drying room. The rinsing tank is arranged proximate to the brush-cleaning tank. The drying room is arranged proximate to the rinsing tank. The rinsing tank includes a sprayer (5) disposed therein. The sprayer includes a tube (51). The tube includes an elongated hollow body and a plurality of nozzle holes (52) defined in the body. The nozzle holes are arranged along an axial direction of the tube. Diameters of the nozzle holes are progressively decreasing along the axial direction. The sprayer is capable of cleaning the substrate with a relatively small total amount of deionized water.

### FIELD OF THE INVENTION

The present invention relates to sprayers for dispensing water to clean substrates, and to cleaning apparatuses using the sprayers.

### BACKGROUND

A cleaning process is often used for cleaning substrates such as those used in making liquid crystal display devices (LCDs) or semiconductor devices. The substrate is commonly a glass substrate, or a silicon wafer. The substrate generally needs to be cleaned before a subsequent process is performed. A cleaning process is generally performed with a cleaning apparatus.

Referring to FIG. 5, this represents a conventional cleaning apparatus 1. The cleaning apparatus 1 includes a brush-cleaning tank 11, a high-pressure rinsing tank 12, a final rinsing tank 13, and a drying room 14. The brush-cleaning tank 11, the high-pressure rinsing tank 12, the final rinsing tank 13, and the drying room 14 are connected together in that order.

Referring to FIG. 6, this shows a process for cleaning a substrate 2, the process using the cleaning apparatus 1. The cleaning process includes the following steps. Firstly, the substrate 2 to be cleaned is horizontally transported into the brush-cleaning tank 11. A plurality of rollers 111 supports and moves the substrate 2 forward. When the substrate 2 is conveyed into the brush-cleaning tank 11, a plurality of brushes 113 mounted on brushing devices 112 comes into contact with and brushes two opposite surfaces 21, 22 of the substrate 2. The brushes 113 can brush the substrate 2 by way of relative movement between the brushes 113 and the substrate 2. The brushes 113 can also be rotated while brushing the substrate 2. The substrate 2 is transported into the high-pressure rinsing tank 12, and is inclinedly supported by a plurality of rollers 121. A plurality of sprayers 122 is arranged in the high-pressure rinsing tank 12. The sprayers 122 are connected with a deionized water (DIW) source (not shown) having a pressure between about 6 and about 10 Mpa. The DIW dispensed from the sprayers 122 strikes the opposite surfaces 21, 22 of the substrate 2 so as to rinse the substrate 2. The substrate 2 is then transported into the final rinsing tank 13, and is inclinedly supported by a plurality of rollers 131. A plurality of sprayers 132 arranged in the tank 13 is connected with a DIW source (not shown) having a pressure of about 0.4 Mpa. The DIW dispensed from the dispensing nozzle hole 132 rinses the substrate 2 completely. Finally, the cleaned substrate 2 is transported into the drying room 14, and is horizontally supported by a plurality of rollers 141. A plurality of air knives 142 arranged in the drying room 14 applies high-pressure air streams on the surfaces 21, 22 of the substrate 2 until the residual water on the substrate 2 is removed. The substrate 2 is thus dried.

FIG. 7 shows a structure of one of the sprayers 122, and FIG. 8 schematically shows a spatial relationship between nozzle holes 1221 of the sprayer 122 and the substrate 2 during rinsing. The substrate 2 is transported in the tanks 12, 13, and is sloped at an angle θ with respect to a horizontal surface 3, so that the DIW dispensed on the substrate 2 can flow downwardly from the upper portions of the substrate 2 to the lower portions thereof. The nozzle holes 1221 of the sprayer 122 have a same diameter, and are spaced apart at regular intervals. Each sprayer 132 has a structure substantially the same as that of each sprayer 122.

The above mentioned structures of the sprayers 122, 132 have some disadvantages. In particular, the nozzle holes of the sprayers 122, 132 have a same diameter, and are spaced apart at regular intervals. An amount of the DIW dispensed on upper portions of the substrate 2 is equal to that of the DIW dispensed on the lower portions of the substrate 2. The DIW dispensed on the upper portions of the substrate 2 flows down and facilitates cleaning of the entire surface of the substrate 2. However, the DIW dispensed on the lower portions of the substrate 2 flows down and only facilitates cleaning of corresponding lowest portions of the substrate 2. Consequently, in relative terms, a certain amount of DIW that is dispensed over the lower portions of the substrate 2 is wasted.

What are needed, therefore, are a sprayer and a cleaning apparatus which are capable of efficiently using DIW in a process of cleaning substrates.

### SUMMARY

A sprayer for use in a cleaning apparatus for cleaning substrates includes a tube. The tube includes an elongated hollow body and a plurality of nozzle holes defined in the body. The nozzle holes are arranged along an axial direction of the tube. Diameters of the nozzle holes are progressively decreasing along the axial direction.

A cleaning apparatus for cleaning a substrate includes a brush-cleaning tank, a rinsing tank, and a drying room. The rinsing tank is arranged proximate to the brush-cleaning tank. The drying room is arranged proximate to the rinsing tank. The rinsing tank includes a sprayer disposed therein. The sprayer includes a tube. The tube includes an elongated hollow body and a plurality of nozzle holes defined in the body. The nozzle holes are arranged along an axial direction of the tube. Diameters of the nozzle holes are progressively decreasing along the axial direction. In operation, the larger nozzle holes spatially correspond to an upper portion of the substrate, to dispense a large amount of DIW over the upper portion of the substrate. The smaller nozzle holes spatially correspond to a lower portion of the substrate, to dispense a smaller amount of DIW over the lower portion of the substrate. The sprayer is capable of cleaning the substrate with a relatively small total amount of DIW.

Other objects, advantages, and novel features will become more apparent from the following detailed description when taken in conjunction with the accompanying drawings, in which:

### BRIEF DESCRIPTION OF THE DRAWINGS

FIG. 1 is a side plan view of a sprayer according to a first embodiment of the present invention, the sprayer comprising a plurality of nozzle holes;

FIG. 2 is a schematic, side view of the sprayer of FIG. 1 and a substrate during a cleaning process, schematically showing a spatial relationship between the nozzle holes of the sprayer and the substrate;

FIG. 3 is a side plan view of a sprayer according to a second embodiment of the present invention;

FIG. 4 is an isometric view of the sprayer of FIG. 3;

FIG. 5 is a schematic representation of a conventional cleaning apparatus;

FIG. 6 is a schematic, side view of the cleaning apparatus of FIG. 5, showing a process of cleaning a substrate therein;

FIG. 7 is an enlarged, side plan view of a sprayer used in the cleaning apparatus of FIG. 5, the sprayer comprising a plurality of nozzle holes; and

FIG. 8 is a schematic, side view of the sprayer of FIG. 7 and the substrate of FIG. 6 during the cleaning process, schematically showing a spatial relationship between the nozzle holes of the sprayer and the substrate.

### DETAILED DESCRIPTION OF PREFERRED EMBODIMENTS

Reference will now be made to the drawings to describe embodiments of the present invention in detail.

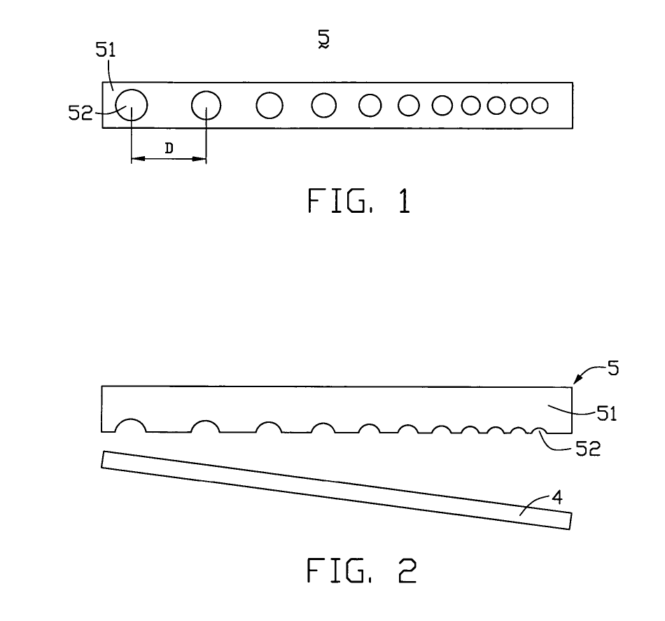

Referring to FIG. 1, a sprayer 5 in accordance with a first embodiment of the present invention includes a tube 51. The tube 51 is generally a hollow body for allowing DIW to flow therethrough. In particular, the tube 51 is an elongated cylinder, and a flow channel (not visible) is axially defined therein. A plurality of nozzle holes 52 is arranged linearly along an axial direction of the tube 51, and communicates with the flow channel. Diameters of the nozzle holes 52 progressively decrease along the axial direction. Further, a pitch D between adjacent nozzle holes 52 progressively decreases along the axial direction.

Referring to FIG. 2, this schematically shows a spatial relationship between the nozzle holes 52 of the sprayer 5 and a substrate 4 to be cleaned during a cleaning process. In operation, the larger nozzle holes 52 spatially correspond to an upper portion of the substrate 4, to dispense a large amount of DIW over the upper portion of the substrate 4. The smaller nozzle holes 52 spatially correspond to a lower portion of the substrate 4, to dispense a smaller amount of DIW over the lower portion of the substrate 4. The DIW dispensed on the upper portion of the substrate 4 flows downwardly to facilitate cleaning of the entire surface of the substrate 4. The smaller amount of DIW dispensed on the lower portion of the substrate 4 flows downwardly to facilitate cleaning of the lowest portions of the substrate 4. Consequently, compared with a conventional sprayer, the sprayer 5 of the present embodiment is capable of cleaning the substrate 4 with a relatively small total amount of DIW.

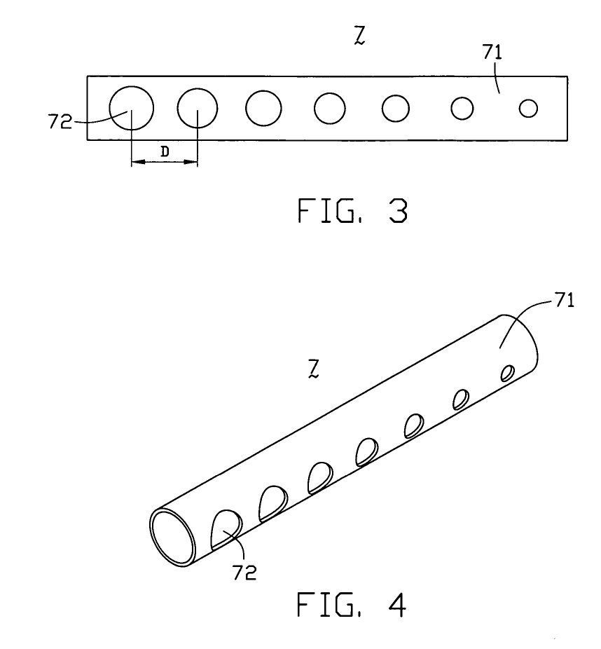

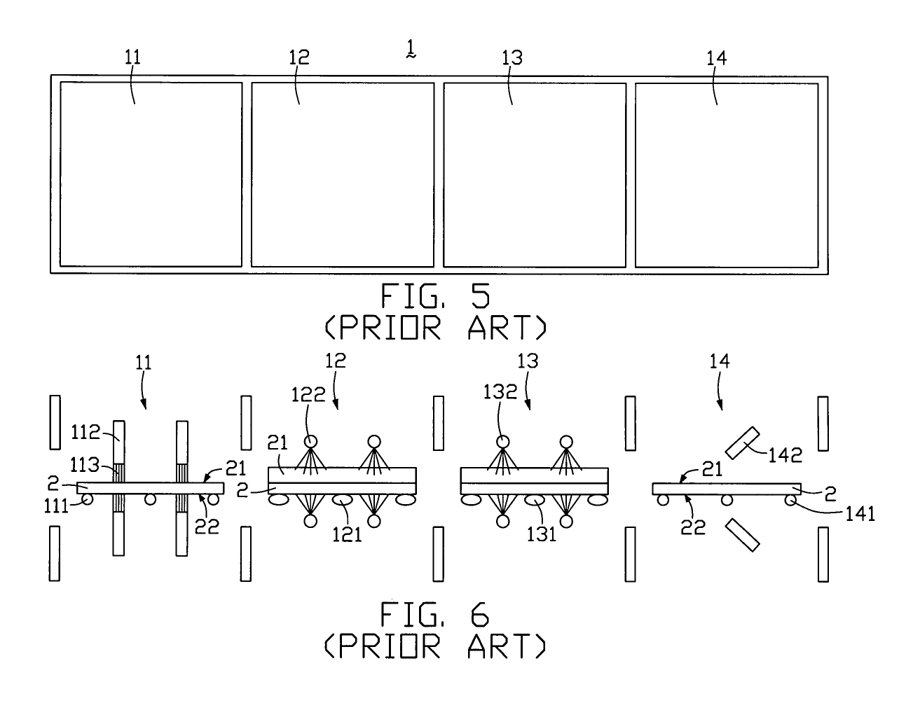

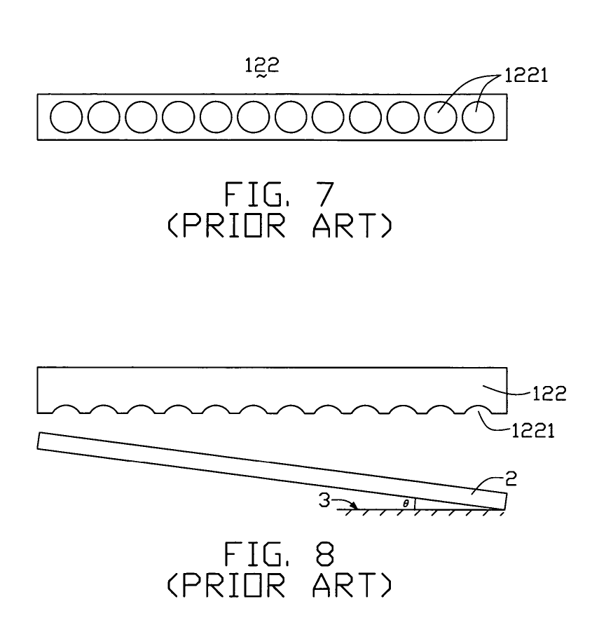

Referring to FIG. 3 and FIG. 4, a sprayer 7 in accordance with a second embodiment of the present invention includes a tube 71. The tube 71 is generally a hollow body for allowing DIW to flow therethrough. In particular, the tube 71 is an elongated cylinder, and a flow channel (not visible) is axially defined therein. A plurality of nozzle holes 72 is defined in the tube 71. The nozzle holes 72 are arranged linearly along an axial direction of the tube 71, and communicate with the flow channel. Diameters of the nozzle holes 72 progressively decrease along the axial direction. A pitch D between adjacent nozzle holes 72 is constant.

The sprayers 5, 7 of the exemplary embodiments of the present invention can be employed in a cleaning apparatus similar to the cleaning apparatus 1 described above. In one example, an exemplary cleaning apparatus includes a brush-cleaning tank, a rinsing tank arranged proximate to the brush-cleaning tank, and a drying room arranged proximate to the rinsing tank. The rinsing tank includes the sprayer 7 arranged therein. The sprayer 7 has the elongated tube 71, and the plurality of nozzle holes 72 defined in the tube 71. The nozzle holes 72 are arranged along the axial direction of the tube 71, with diameters of the nozzle holes 72 progressively decreasing along the axial direction.

It is to be understood, however, that even though numerous characteristics and advantages of the exemplary embodiments have been set forth in the foregoing description, together with details of the structures and functions of the exemplary embodiments, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A sprayer for use in a cleaning apparatus for cleaning substrates, the sprayer comprising:
a tube comprising an elongated hollow body and a plurality of nozzle holes defined in the body, the nozzle holes being arranged along an axial direction of the tube, diameters of the nozzle holes progressively decreasing along the axial direction.

2. The sprayer as claimed in claim 1, wherein the nozzle holes are equidistantly spaced from each other.

3. The sprayer as claimed in claim 1, wherein a pitch between adjacent nozzle holes progressively decreases along the axial direction.

4. A cleaning apparatus for cleaning a substrate, comprising:
a brush-cleaning tank;
a rinsing tank arranged proximate to the brush-cleaning tank, the rinsing tank comprising a sprayer disposed therein, the sprayer comprising an elongated hollow body and a plurality of nozzle holes defined in the body, the nozzle holes being arranged along an axial direction of the tube, diameters of the nozzle holes progressively decreasing along the axial direction; and
a drying room arranged proximate to the rinsing tank.

5. The cleaning apparatus as claimed in claim 4, wherein the nozzle holes are equidistantly spaced from each other.

6. The cleaning apparatus as claimed in claim 4, wherein a pitch between adjacent nozzle holes progressively decreases along the axial direction.

7. The cleaning apparatus as claimed in claim 4, wherein the drying room comprises a plurality of air knives arranged therein.

8. A sprayer for use in a cleaning apparatus for cleaning substrates, the sprayer comprising:
an elongated body defining a plurality of nozzle holes therein, the nozzle holes being arranged along a lengthwise direction of the body, diameters of the nozzle holes progressively decreasing along the lengthwise direction.
